(19) United States
(12) Patent Application Publication
(10) Pub. No.: US 2017/0193124 A1
(43) Pub. Date: Jul. 6, 2017

(54) Cloud-Based Universal Tagging System

(71) Applicant: Alex C. Y. Wong, JR., Cambridge (GB)

(72) Inventor: Alex C. Y. Wong, JR., Cambridge (GB)

(73) Assignee: RedBite Solutions Ltd., Cambridge (GB)

(21) Appl. No.: 14/748,089

(22) Filed: Jun. 23, 2015

(51) Int. Cl. G06F 17/30; G06K 7/10; G06K 7/14

(52) U.S. Cl. CPC G06F 17/30879; G06F 17/30887; G06K 7/1417; G06K 7/10297; G06K 2007/10524

(57) ABSTRACT

A system comprising a physical object comprising at least one readable identifier, the readable identifier being associated with a uniform resource identifier (URI), the URI having associated with it a set of descriptors which describe properties of the object.

FIELD OF INVENTION

The invention relates to a system of associating a uniform resource identifier (URI) to a physical object, in order to allow information relating to the object to be accessed for any purpose.

### BACKGROUND

It is known to attach an identifier, such as a barcode or an RFID tag or the like, to an item. Typically a database is established which has a set of descriptors associated with the identifier. In this way, if the identifier is read or scanned, the set of descriptors can be retrieved regarding that object.

Often the object in question is generic, such as a clothing garment. However the identifier is often unique, and therefore the presence of the identifier makes the item unique.

Such databases including a set of descriptors may be searched even if the identifier is lost, damaged or is otherwise unreadable. This can be achieved by inputting known facts about the item such as its size, shape, color etc.

### SUMMARY OF INVENTION

The present invention relates to the methods in which RFID devices that generates large amount of data can directly communicate with the cloud application without the need for a middleware. This invention relates to both the cloud application and the RFID devices working together in unison. This involves methods residing on the cloud application working

In an aspect the invention relates to a system comprising a physical object comprising at least one readable identifier, the readable identifier being associated with a uniform resource identifier (URI), the URI having associated with it a set of descriptors which describe properties of the object.

### BRIEF DESCRIPTION OF THE DRAWING(S)

The invention will now be illustrated by way of example.

FIG. 1 shows a system where the label consists of multiple identifiers to be scanned by a variety of devices, but refers to the same unique object. These identifiers can be of different identifier numbers.

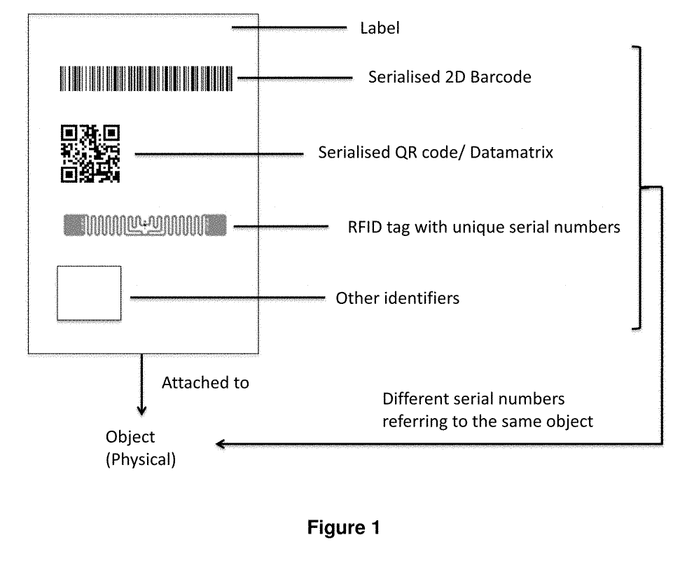

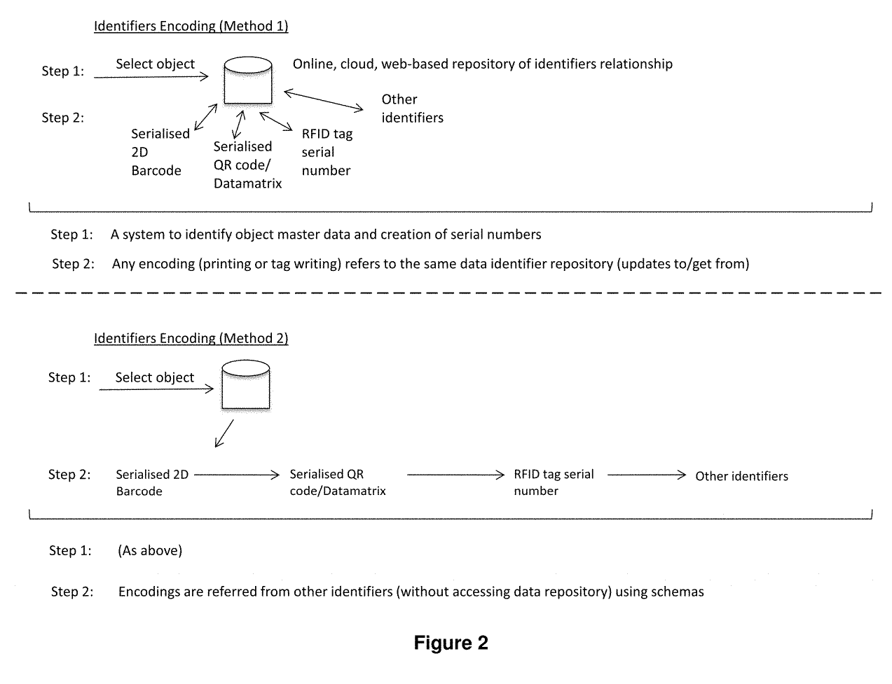

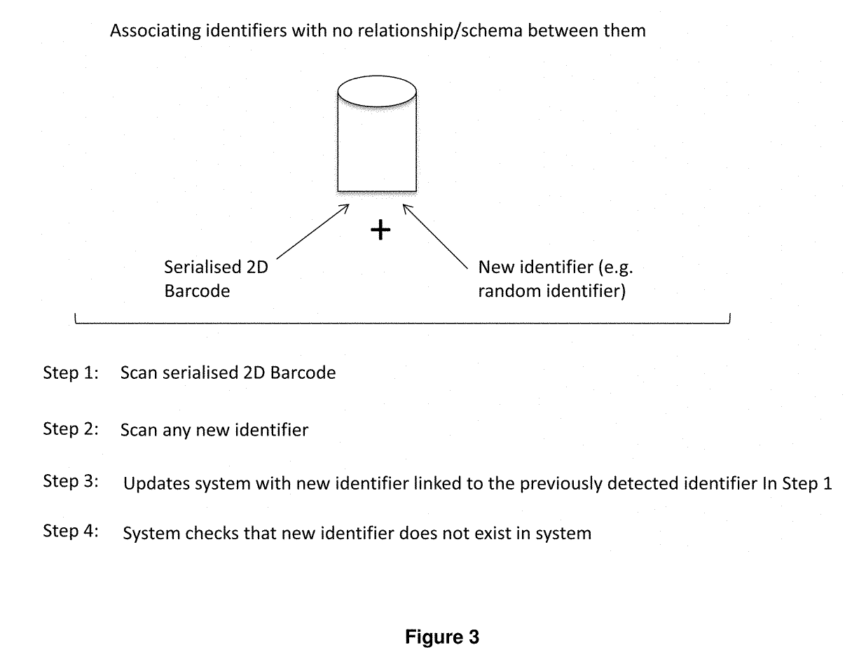

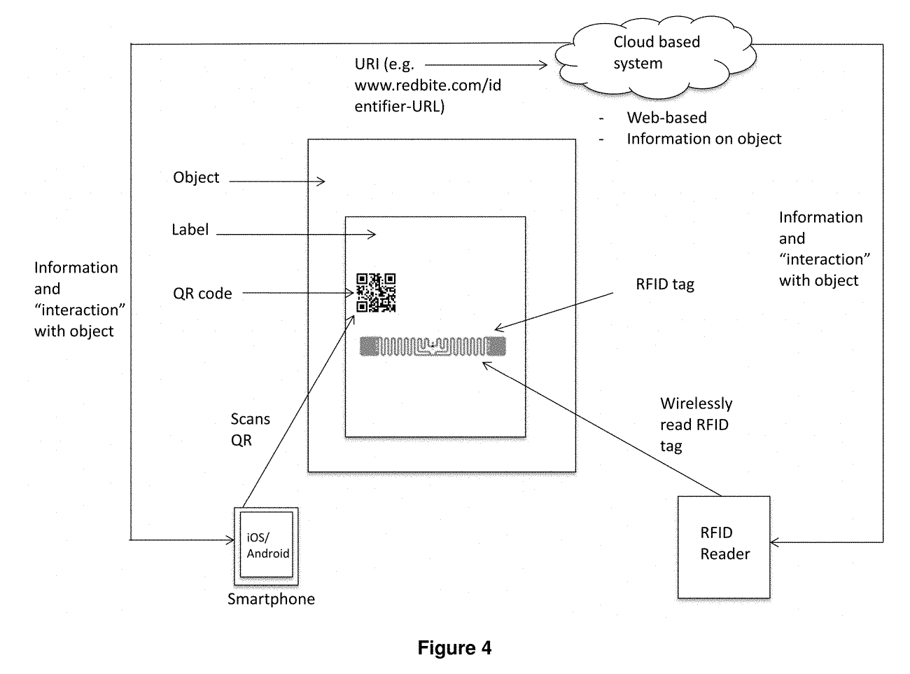

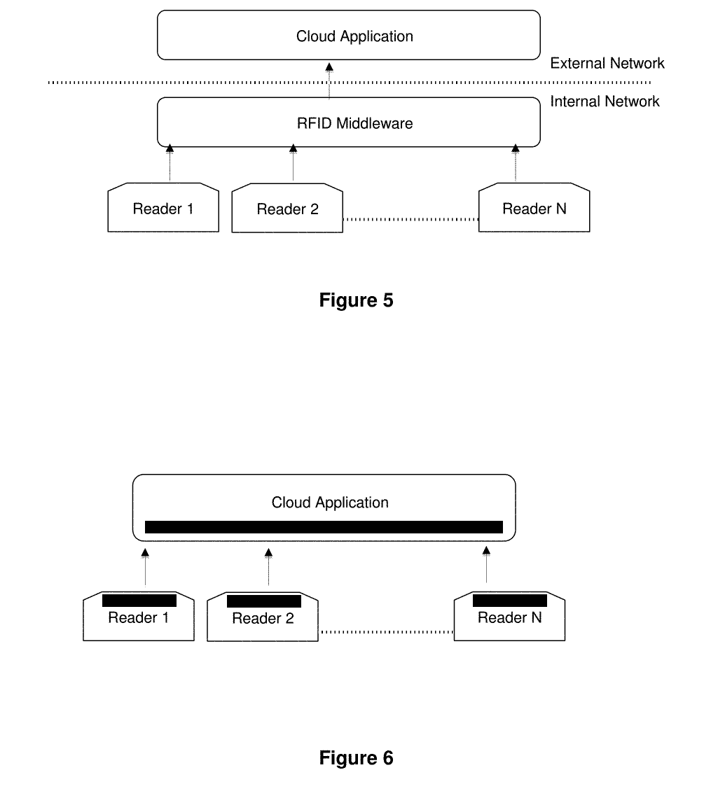

The method in which those identifiers could be derived could be through in a single or multiple steps (FIG. 2). When the object has been identified (through selecting the right master data), a single/multiple identifiers are created from by the system (and could be held in a repository). When printing/writing the tag, all identifiers will be generated by the system (held by the repository) and produced correspondingly (Method 1).

It is also possible that as in FIG. 2 Method 2, after the object has been identified and a single identifier encoded/printed/written, that other identifiers are then derived and encoded/printed/written based on the previous identifiers (or any identifiers already exists on the label).

FIG. 2 shows identifiers that have been generated to have some form of associated schema/information relating to each other. However, FIG. 3 shows that a completely new identifier (even say completely random numbers) that has already been printed/encoded/written, could be associated with the existing identifier. This can be achieved by scanning existing identifier and then links the new identifier to it via an update to the system.

The identifiers, when detected/scanned, by various methods and devices (as shown in FIG. 4), will retrieve different/same serial numbers depending on the devices via the object label(s), and information about the object is then retrieved from a URI from the cloud-based system which holds information about the object. This will allow the devices to be able to “interact” with the object using via the URI.

The said URI can for example a unique, permanent link on the cloud refers to the object and would be the source of the object information and interaction. This means that there will be a permanent link for every single object that is registered with the system. One of the methods to enable such large number of objects is to use UUID (Universally Unique Identifier) appended to a domain name, for example www.redbite.com/UUID or of similar format.

We also describe a way in which an RFID device could communicate directly to the cloud without any onsite middleware application. Radio Frequency Identification (RFID) devices (e.g. RFID fixed readers, RFID handheld readers) generates a large amount of data from reading RFID tags repetitively in their environment. RFID readers in particular could theoretically read up to 1200 unique 96-bit tags per second (http://alumni.media.mit.edu/˜pappu/pdfs/MaguirePappuIEEETrans2009.pdf). This can generate a large amount of data from the tag reporting, but the communication protocol between readers and server will further add more bandwidth to the network. Furthermore, when there are multiple readers in the network, a typical network deployment includes a middleware that sits within the local network, similar to FIG. 5.

This middleware aggregates the heavy-bandwith communication information from RFID reader in the same internal network, before subsequently passing it on to another application in the cloud in an external network.

### DETAILED DESCRIPTION

We describe methods and systems in which an advanced cloud-based tracking is possible to identify all the “things” in the world using permanent URIs with public and private information using plurality of identifiers representing the same object. Such a system requires novel use of identifiers and cloud capabilities.

This invention is about methods and systems of enabling plurarity of automated identification identifiers (such as QR, RFID) to uniquely identify, retrieve and allow decision making on a virtual or physical object which has a unique URI accessible via cloud infrastructure on multiple devices. These identifiers are then attached to an object to allow for the ability to add unique intelligence and decision making process to each uniquely identified items. Such invention would allow for automated and non-automated tracking in museums, art galleries for example, and also for everyday objects.

The URI can hold public and private information about the object. Publicly available information can be defined by the owner of the object. Selective private information can be accessed depending on the role of the private user logged in.

When the object is scanned and pointed to the URI, users could also add comments on the object, add photos, videos or any attachments relevant to the object. A public profile of the object is available on the unique URI with private data and processes only available depending on the access control of the users logged in. Therefore, different users scanning the same item can be displayed with different information.

Subsequent, business processes, such as stock checks, may be actioned against the URI from either QR or RFID sources. Stock checks against the identifier can be conducted using a “quick stock check” mode where once the identifier is identified, the object is considered “seen” and stock checked. A “full stock check” is when the user is prompted for the quantity of unit attached to the object. A negative stock check presence may also be indicated by the presence of a marker QR code indicating where an item should be, but is not. Interacting with the URI allows the user to mark the item as missing.

Stock check can be conducted using the RFID device rapidly during a “quick stock check” mode as RFID allows multiple tagged objects to be identified rapidly and quickly without the need to enter quantity of the unit attached to the object. With the same label, a smartphone can use the QR code printed on the label to perform the stock check at the same time, and collectively, stock check conducted by both devices can be aggregated into a single stock check.

When conducting stock check on the smartphone based on serialized QR or barcode, the vision system on the smartphone can be continuously switched on in such a way that it will be able to detect the barcode continuously and therefore allow for a mass stock check instead of individually stock checking the barcode.

When locating a desired tagged object with RFID handheld, as the RFID handheld can read multiple tags up to 1-2 metres away, the system will automatically step reduce the power level of the RFID device every time the tagged object is detected so that the user will be required to move closer to the item until it is finally identified at very close range.

The URI not only contain static information, but it will allow the ability to embed software intelligence that would represent the desired behavior of the object (this can be opened up to third party developers/users with the right authorization process). For example, this will enable an inanimate object with a URI representation to have the ability to make its own decision relating to its destiny (such as automated reordering of spare parts). This also to allow the ability to extend the object's capability in the future to include the ability to speak and interact with the users via the smartphone. For example, once the user has used the smartphone to identify the object, it can ask the object a question (and using natural language processing), the object can respond back to the user using synthetic voice via the smartphone or other means of interaction for example through Google Glass.

Using a continuous vision detection system (such as Google Glass), the webcam on the device could be used to automatically detect the QR barcode of tagged objects in the surrounding area automatically without the need for the user to actively find and scan the barcode/QR code. Once a barcode/QR code is detected by such system, then, it can for example automatically display information about the object after deriving its information from its URI in the cloud (or other repository). This information can be overlaid on to user's vision (on Google Glass for example), and can also include a set of actions that the user could perform. For example, when a bottle of medicine is detected via the barcode, the system would automatically register this reading into the system and using a set of predetermined rules or algorithm, would infer contextual meaning from this (such as for example whether the user has taken the medicine). The system could also perform “background intelligence mining” on the scanned barcode for example on the ownership of the tagged object and it's provenance (and whether it's potentially counterfeit product), and also would be able to ask users for interactions (such as whether the user would like to record into the system on whether the user indeed has taken the medicine). Other relevant information could also be displayed to the user augmented (on the Google Glass) without intervention from the user.

Instead of tagged object, locations can also be tagged with QR, serialized barcode or RFID. Scanning those location will also point to a URI where similar capabilities is also available via the cloud system. In fact, any “things” can be tracked and scanned in such a way.

In such a way, in addition to direct identification using some form of (digital) serial number attached or associated with the item, indirect identifications via some form of established signature, or characteristics of sensed information associated with the item (such as pin pointing using location or a unique physical characteristics of the item). For example, a lot of people tracking will be based on unique features-finger prints, retinas and increasingly objects might be identified and tracked in the same way.

Many modern devices (such as smartphones) have built in location detection capability, and this can be used as mechanism to retrieve a list of tagged objects available in that location (and it's URIs). Users could also use the vision system (via snapping a photo) of the device where image recognition could be used to further pinpoint the object's identity instead of using any barcode/RFID tags.

A serialised barcode or QR are static, in that they do not change after it is printed or displayed on the screen. This poses security risks as the serialised barcode or QR can be duplicated from the image taken of them. Instead of static barcode or QR, a method of dynamically changing them (for example via algorithms using genetic algorithm, time, encryption, random numbers etc) and then displaying the changes in real-time on a display screen (or any other methods of dynamically changing the barcode/serialised QR) would allow for a more secure identifier as the temporal identifier would only be valid for that period of them before a new temporal identifier is generated. This is useful for example, when this dynamically changing QR represents a location, and a user needs to proof that he is in that location at a particular time—only by scanning the dynamically changing QR at that particular time in that particular location (where the QR is displayed) that the system could verify that the user is there.

“dynamic QR” where instead of a printed QR that is forever static, a dynamic QR which continuously change (as displayed on smartphone, e-ink, electronic poster, website etc) will be much more secure and hopefully unclonable because they are not static (this of course means dynamic QR is not possible on printed material). This aspect can include say using private algorithm, date time, additional random numbers, environmental conditions, etc. The application for this is broad, so for example, for payment purposes, instead of having a static QR on the smartphone to represent a user or retailer, a dynamic QR is displayed instead for secure transaction between two parties in such a way that if the other party has a photo of the QR at that time, the other party cannot clone it anymore as the QR would have “expired” (but recorded in the database nevertheless).

A QR or serialised barcode could also be encrypted through a public/private key in that only users with the right key would be able to decrypt the information that points to the right URI, thereby preventing even the public information about the object to be known.

The RFID devices are uniquely identified using the QR or other identifier means on the smartphone and users would be able then subsequently be able to control the RFID devices from the cloud.

An RFID device that has a software embedded in the RFID reader will create a random unique ID automatically and sends the RFID device information such as MAC address automatically to the cloud application.

The RFID device will then be assigned to a specific user and location based on the unique ID and MAC address of the reader plus other identifiers.

The RFID reader can then be updated remotely and managed directly from the cloud to the device without the need for any application middleware.

The software agent on the reader will accumulate tag reads if the networking is down and sends those tag reads directly to the cloud application when the Internet is available.

The software agent on the reader also compresses tag reads, filters away redundant read before sending the information to the cloud to minimize bandwidth.

Another feature of the invention is the tagging process-currently most tagging process require selection of the master data (e.g. Manufacturer→model number etc), but it is possible to tag an object just by taking a photo. For example, to tag a wine bottle, take a photo of the wine bottle's label and scan the QR or RFID tags and immediately applied it on the object. In the background, our server receives the photo and the identifier of the wine, and either through image recognition or someone behind the scene actually read the label and enter information about the wine bottle.

1. A system comprising a physical object comprising at least one readable identifier, the readable identifier being associated with a uniform resource identifier (URI), the URI having associated with it a set of descriptors which describe properties of the object.

2. A system according to claim 1 wherein the URI is a uniform resource locator (URL).

3. A system according to claim 1, wherein the set of descriptors is a database containing factual details about the object.

4. A system according to claim 1, wherein the readable identifiers are selected from at least one of a barcode, a QR code, an RFID tag.

5. A system according to claim 1, wherein the readable identifier comprises a readable form of the URL.

6. A system according to claim 1, wherein the readable identifier comprises a readable code which code is associated with the URL.

7. A system according to claim 1, wherein the identifier is readable by a device, which has access to the association between the identifier and the URL, in order to obtain the URL once the identifier is read.

8. A system according to claim 7, wherein the device is a smartphone or an RFID handheld, with access to the URI in question.

9. A system according to claim 1, wherein the URI has embedded within it software intelligence.

10. A system according to claim 1, wherein the URI holds both public and private information.

11. A system according to claim 1, wherein the set of descriptors includes the location of the object.

12. A system according to claim 1 wherein the identifier is encrypted.

13. A system according to claim 1, wherein the identifier can be its physical appearance.

14. A method of retrieving information about a physical object, the method comprising employing a system according to any one of the preceding claims, reading the identifier, obtaining the associated URI from the read identifier, thereby obtaining information about the physical object from the set of descriptors associated with the URI.

15. A method of creating a system according to claim 1, the method involving creating an association between a readable identifier and a URI, populating a set of descriptors associated with the URI.

16. A method according to claim 15, the method involving taking a photo of the object and scan the QR or RFID tags and immediately applied it on the object, in the background, a server receives the photo and the identifier of the wine, and either through image recognition or someone reading the label, enters information about the object.

17. A method of adding further readable identifiers to a system according to claim 1, the method involving creating an association between the additional readable identifier and the URI.

18. A method of modifying a system according to claim 1, wherein descriptors are added to, modified or deleted from the set of descriptors.

19. A dynamic identifier which changes with time according to an algorithm.

20. A dynamic identifier according to claim 19, wherein the identifier is a QR code.

21. A system wherein a plurality of RFID identifiers communicate directly to the cloud without any onsite middleware application.
